(19) United States
(12) Patent Application Publication
(10) Pub. No.: US 2009/0011280 A1
(43) Pub. Date: Jan. 8, 2009

(54) Magnetic head manufacturing method, magnetic head, and magnetic storage device

(75) Inventor: Kazuaki Inukai, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/975,466

(22) Filed: Oct. 19, 2007

(30) Foreign Application Priority Data
Jul. 5, 2007 (JP) 2007-177725

(51) Int. Cl. B05D 5/12; G11B 5/33

(52) U.S. Cl. 428/810; 427/129

(57) ABSTRACT

The present invention relates to a magnetic head manufacturing method used for a magnetic storage device. The method includes the steps of forming a first groove in a shape corresponding to an outline of a main magnetic pole on an insulation layer; forming a second groove corresponding to an outline of a main magnetic pole brace layers; inside the outline of the main magnetic pole; and using a plating method to fill the first and second grooves at the same time with a ferromagnetic material and form a main magnetic pole and a main magnetic pole brace layer at the same time.

### BACKGROUND OF THE INVENTION

1. Technical Field

The present invention relates to a magnetic head manufacturing method used for a magnetic storage device.

2. Description of the Related Art

In addition to business applications such as business servers, workstations, and RAID (Redundant Arrays of Inexpensive Disks) which provide high reliability by combining multiple HDD (hard disk drive), magnetic storage devices, such as an HDD, are used in many different applications for consumer information uses including games, audio devices, cellular telephones, and video recorders. The latter market is expected to grow rapidly in the future along with continuing demand for higher storage density in magnetic storage devices. Because the cost per storage bit is especially low for HDDs compared to other magnetic storage devices and the data transfer speed is fast, they are used as mainstream magnetic storage devices. In addition, their storage density increases annually at a ratio of 30% to 100% and mass produced HDD have already realized a surface storage density of 100 Gb/in². In response to anticipated demand for even higher storage densities in the future, the utilization of a perpendicular magnetic storage system has begun as a technology that realizes higher storage densities.

Damascene processes used in a magnetic head manufacturing method of a perpendicular magnetic storage system will be described here. To start, a hard mask layer is formed on an alumina insulation layer, composed of Al₂O₃ for example, and then a stepper forms a pattern corresponding to the outline of the main magnetic pole on the surface of the hard mask layer formed on the insulation layer. Next, with the pattern of the hard mask layer as a mask, reactive ion etching (RIE) is used to form a groove on the insulation layer. The groove corresponds to the outline of the main magnetic pole layer. Next, after removing the hard mask a plated base layer is formed and a plating method deposits a ferromagnetic body (material of a main magnetic pole layer) in the groove formed by RIE. Thereafter, a main magnetic pole layer is formed using CMP (Chemical Mechanical Polish) to flatten the upper surface of the main magnetic pole layer. An advantage of this Damascene process is that, because the main magnetic pole layer is embedded in a previously formed groove, the main magnetic pole layer can be formed with high precision compared to a conventional FIB process.

The main magnetic pole layer is extremely thin at approximately 0.3 μm. Because of this, a main magnetic pole brace layer that supports the main magnetic pole layer is required. The main magnetic pole brace layer is normally composed of the same material as the main magnetic pole and is approximately 0.6 μm to 0.8 μm thick. With this thickness, the main magnetic pole brace layer is substantially stronger than the main magnetic pole layer. The main magnetic pole brace layer can be formed using the Damascene process mentioned above. In other words, in order to form the entire main magnetic pole that includes the main magnetic pole layer and the main magnetic pole brace layer, the main magnetic pole brace layer must be formed and undergo CMP polishing to flatten the upper surface thereof before forming the main magnetic pole and implementing CMP. Thus, the CMP process must be performed twice. However, a problem with CMP polishing is that it is difficult to control the film thickness and large variations of the order of +/−0.5 μm occur. If variation in film thickness occurs in the main magnetic pole brace layer, it becomes difficult to produce a main magnetic pole layer with a stable shape on the main magnetic pole brace layer.

When the main magnetic pole layer cannot be formed in a stable shape, there is concern that a side erasing problem will occur. There is also concern that variation will occur in the write magnetic field generating from the edge surface of the edge of the main magnetic pole layer impeding normal recording operations. In order to prevent this type of problem from occurring, a method is required that forms a main magnetic pole layer without using a CMP process during the process that forms the main magnetic pole brace layer and the main magnetic pole layer. The object of the present invention is to find a method that can form a main magnetic pole layer without using a CMP process after forming a main magnetic pole brace layer. Another object is to find conditions that allow the angle of the tapered shape of the edge surface of the edge of the main magnetic pole layer to be controlled to an arbitrary angle.

### SUMMARY

In accordance with an aspect of an embodiment, a method for manufacturing a magnetic head includes the steps of forming a first groove in a shape corresponding to an outline of a main magnetic pole on an insulation layer forming a second groove corresponding to an outline of a main magnetic pole brace layer; inside the outline of the main magnetic pole; and using a plating method to fill the first and second grooves at the same time with a ferromagnetic material to form a main magnetic pole and a main magnetic pole brace layer at the same time.

### BRIEF DESCRIPTION OF THE DRAWINGS

FIG. 1 is an internal schematic view of a common magnetic storage device wherein a magnetic head of a first embodiment, which is a typical example of the present invention, is used;

FIG. 2 is a cross sectional view of the magnetic head of the first embodiment;

FIG. 3 shows the magnetic head of the first embodiment as seen from an air bearing surface;

FIG. 4 is a perspective view that clarifies a positional relationship of a main magnetic pole brace layer, a main magnetic pole layer, a junction portion, and a thin film coil of the first embodiment;

FIGS. 5A to 5I are cross sectional views of a magnetic head after a conventional type main magnetic pole formation process, used for comparison with the first embodiment;

FIGS. 6A to 6I are an end view of an air bearing surface of a magnetic head after the conventional type main magnetic pole formation process used for comparison with the first embodiment;

FIGS. 7A to 7G are cross sectional views of a magnetic head showing a main magnetic pole formation process of the first embodiment;

FIGS. 8A to 8G are end views of an air bearing surface in the main magnetic pole formation process of the first embodiment;

FIG. 9 shows a relationship of pressure and temperature with respect to taper angle in the main magnetic pole formation of the first embodiment.

### DETAILED DESCRIPTION OF THE EMBODIMENT

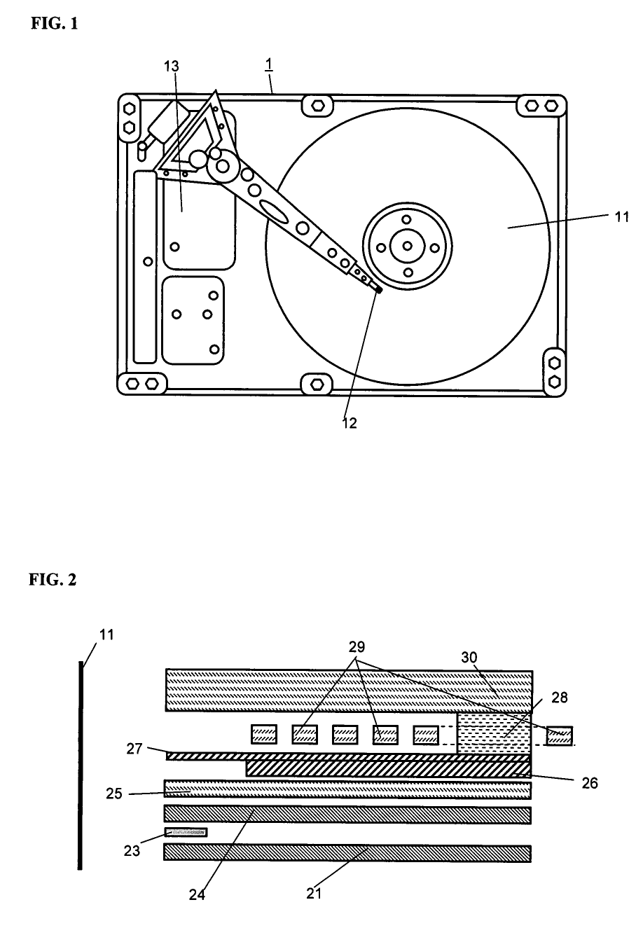

In the following an embodiment of the present invention will be described referring to FIG. 1 to FIG. 9. The methods to form each layer except for the main magnetic pole layer and the main magnetic pole brace layer include common sputtering and plating methods. Each layer can be formed into the desired shape using photolithography. Thus, a detailed description of these formation processes will be omitted. FIG. 1 is an internal schematic view of a common magnetic storage device wherein the magnetic head of the first embodiment of the present invention is used. A recording medium 11, a head slider 12 where the magnetic head is mounted, and a head amplifier IC 13 that functions to control the storage read signals as well as supply power to the magnetic head are arranged inside the magnetic storage device 1.

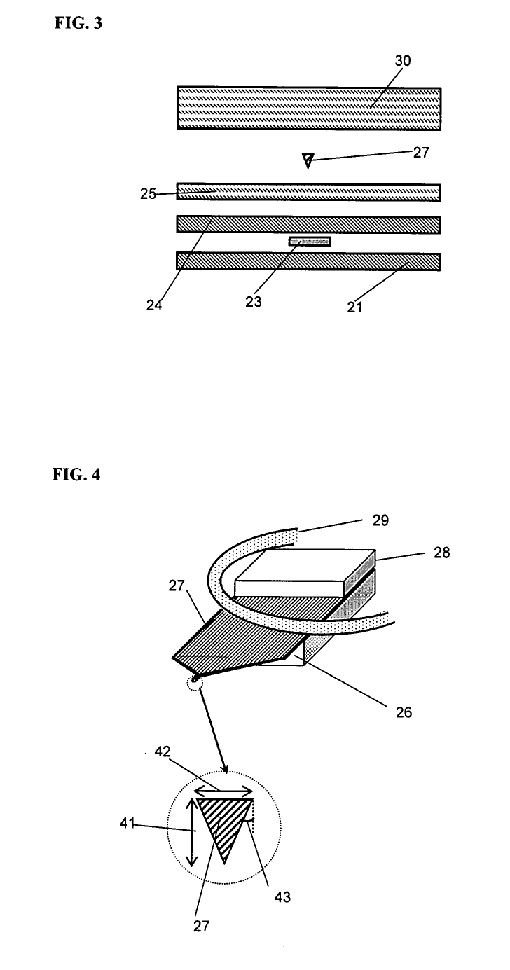

FIG. 2 is a cross sectional view of the magnetic head of the first embodiment. An air bearing surface side is in the direction where the recording medium 11 is arranged. FIG. 3 shows the magnetic head of the first embodiment as seen from the air bearing surface. To start, as shown in FIG. 2 and FIG. 3, a sputtering method is used to form a 2 μm thick alumina layer composed of Al₂O₃ as an insulation layer on an alumina titanium carbide layer (not shown in the figures) composed of Al₂O₃—Ti—C at a thickness of approximately 2 mm. Next, a plating method is used to form a lower magnetic shield 21, composed of a soft magnetic material such as Ni—Fe, on the insulation layer. Next, although not shown in the figure, a sputtering method is used to form a 0.6 μm thick alumina layer as a first read gap on the lower magnetic shield 21 side. Then, a GMR or TuMR read element 23 with a conventional construction is formed so as to be close to the recording medium 11. Next, although not shown in the figure, a sputtering method is used to form a 0.6 μm thick alumina layer as a second read gap below an upper magnetic shield 24 side. Then, the upper magnetic shield 24, composed of a soft magnetic material, is formed in the same manner as the lower magnetic shield 21. The manufacturing process up to this point is the manufacturing process of the recording element of the magnetic head. The GMR or TuMR read element 23 is constructed so as to be sandwiched between the upper and lower magnetic shields 21, 24 via insulation layers.

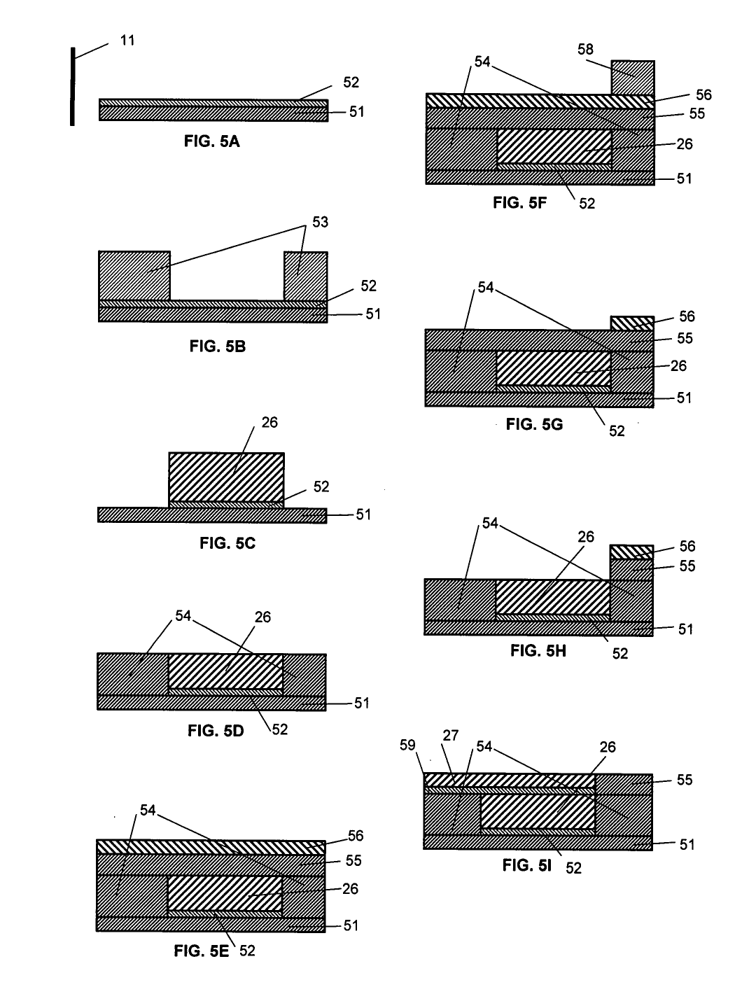

In the following, the method to form a recording element will be described. At first, although not shown in the figure, a 0.3 μm thick alumina layer is formed on the upper magnetic shield 24 of FIG. 2. Next, a plating method is used to form a magnetic shield 25 composed of a soft magnetic material such as Ni—Fe. Then, the main magnetic pole brace layer 26, that supports the main magnetic pole layer, and the main magnetic pole layer 27 are formed. Note that FIG. 5 and later figures will be used to describe details of processes to form the main magnetic pole brace layer 26 and the main magnetic pole layer 27. Next, a plating method is used to form a junction portion 28, a thin film coil 29, and a return yoke 30. Although not shown in the figure, the empty portion between the main magnetic pole brace layer 26, the main magnetic pole layer 27, the junction portion 28, the thin film coil 29, and the return yoke 30 is filled with alumina layers using a sputtering method or a plating method.

FIG. 4 is a perspective view that clarifies the positional relationship of the main magnetic pole brace layer 26, the main magnetic pole layer 27, the junction portion 28, and the thin film coil 29 of the first embodiment. The main magnetic pole layer 27 is supported by means of the main magnetic pole brace layer 26 and the edge surface of the edge of the main magnetic pole layer 27 has a tapered shape. A width 42 is 0.02 μm and a height 41 is 0.03 μm. An angle 43 is the allowed skew angle which changes depending on the track density, but is in a range of approximately 30° to 800.

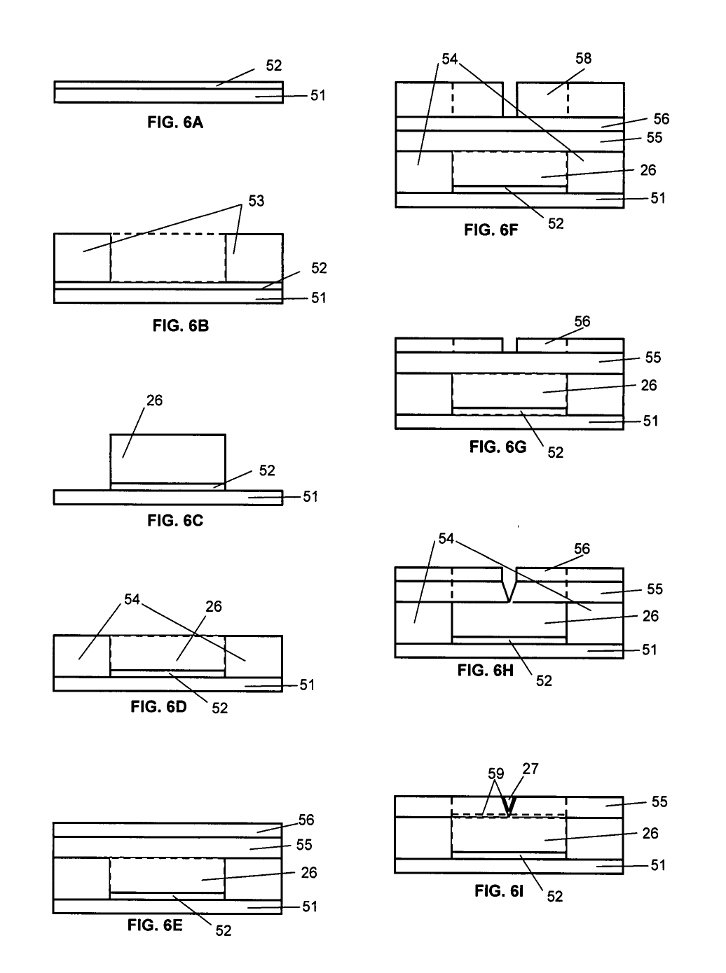

The detailed process to form the main magnetic pole of the present invention will be described here together with an example of the conventional manufacturing method for comparison. FIGS. 5A to 5I and FIGS. 6A to 6I show a conventional main magnetic pole formation process used for comparison with the first embodiment. FIGS. 5A to 5I show cross sections after completing each process while forming the main magnetic pole. In the following, cross sections show a cross section through a central portion of an edge surface. The side where the recording medium 11 is positioned is the direction of the air bearing surface. FIGS. 6A to 6I show edge surfaces on the air bearing surface side and correspond to FIGS. 5A to 5I. The following describes details of FIGS. 5A to 5I and FIGS. 6A to 6I.

First, Ti at a thickness of approximately 5 nm to 10 nm is formed as a plating base layer 52 on an alumina layer 51 composed of Al₂O₃ (FIG. 5A, FIG. 6A). Then, an Ni—Fe based alloy at a thickness of approximately 50 nm is formed thereon.

As seen in FIG. 5B and FIG. 6B, a spin coat method is used to form a Novolac resin containing a light sensitive agent on the plating base layer 52 as a resist layer 53. Thereafter, the resist layer 53 is patterned so as to correspond to the outline of the main magnetic pole brace layer 26 using a KrF stepper.

Referring now to FIG. 5C and FIG. 6C), an electrolytic plating method is used to form a metal that exhibits ferromagnetic properties, such as No—Fe, Fe—Co, or Co—Ni—Fe based alloys, at a thickness of approximately 1.5 μm in the groove of the patterned resist layer 53. This is the main magnetic pole brace layer 26. Thereafter, an IPA (Isopropyl Alcohol) solution is used to remove the resist layer 53. Next, a wet etching method using an acid such as nitric acid or persulfuric acid is used to remove the plating base layer 52 formed directly under the resist layer 53.

As seen in FIG. 5D and FIG. 6D, a sputtering method is used to form an alumina layer 54 at a thickness sufficient to cover the main magnetic pole brace layer 26 and then the main magnetic pole brace layer 26 is polished by CMP until the thickness reaches, for example, 0.6 μm.

A sputtering method is used to form an alumina layer 55 at a thickness of approximately 0.2 μm to 0.4 μm (FIG. 5E, FIG. 6E). Thereafter, a hard mask layer 56 that is a compound layer of, for example, Ni—Fe-based alloy, Fe—Co-based alloy, or Ta/Ni-based alloy is formed on the alumina layer 55 at a thickness of approximately 40 nm to 300 nm. The hard mask layer 56 has substantially the same function as the resist layer. The resist layer (composed of a resin material) has an etching rate higher than the alumina layer. Because of this, the resist layer is not suitable for etching the alumina layer. In contrast, the hard mask layer (composed of a metallic material) has an etching rate 1/10 or less of that of the alumina layer. Because of this, the hard mask layer is not suitable for etching the alumina layer.

Referring to FIG. 5F and FIG. 6F, a spin coat method is used to form a Novolac resin that contains a light sensitive agent as a resist layer 58 and the resist layer 58 is patterned so as to correspond to the outline of the main magnetic pole layer 27. In recent years, the dimensions of the main magnetic pole layer 27 have been becoming smaller to support higher recording densities. To support these increasing densities, a process that allows smaller dimensions than the KrF stepper can be used. For example, an EB (Electron Beam) stepper or an Ar—F stepper may be used.

With the patterned resist layer 58 as a mask, RIE is used to dry etch the hard mask layer 56 patterning the hard mask layer 56 so as to correspond to the outline of the main magnetic pole layer 27 (FIG. 5G, FIG. 6G). Next, the resist layer 58 is removed by means of O₂ ashing. The process gas used for the RIE of the hard mask layer 56 is a gas that can generate a material reactive to the metal of the hard mask layer. For example, it can be a gas selected from among BC1₃, C1₂, CH₃OH, CO, NH₃, O₂, and Ar or a mixture of these gases.

With the patterned hard mask layer 56 as a mask, RIE is used to perform a dry etch to etch the alumina layer 55 (FIG. 5H, FIG. 6H). Here, the shape of the groove corresponding to the outline of the main magnetic pole layer 27 is formed in the center of the alumina layer 55. Next, wet etching is used to remove the remaining hard mask layer 56. In addition, the groove that corresponds to the outline of the main magnetic pole layer edge in FIG. 6H has a tapered shape. The reason for this is to allow anisotropy in the etching by controlling the temperature and pressure during RIE.

As seen in FIG. 5I and FIG. 6I, a layer of a nonmagnetic metal selected from, for example, Ti, Ru, Ta, or Cr, is formed at a thickness of approximately 5 nm to 10 nm as the plating base layer 59. Next, an electrolytic plating method is used to form the main magnetic pole layer 27 using a strong magnetic material selected from among, for example, Ni—Fe or Fe—Co-based alloys. Then, lastly, CMP is used to polish the main magnetic pole layer 27 until the thickness reaches approximately 0.3 μm.

The above describes a conventional manufacturing method. CMP is performed twice in a conventional manufacturing method. Because of this, there is a problem of variation occurring in film thickness. In other words, a polishing process through the use of CMP must be performed during the process that forms the main magnetic pole layer and the main magnetic pole brace layer. Therefore, film thickness variation occurs in the main magnetic pole brace layer formed under the main magnetic pole layer. This results in the film thickness variation due to the main magnetic pole brace layer overlapping adding to that of the main magnetic pole layer formed on the upper side, thereby making it difficult to form the main magnetic pole with favorable accuracy. In addition to this, because the main magnetic pole layer and the main magnetic pole brace layer are divided by a nonmagnetic material, adverse effects spread from the main magnetic pole to where the effective write magnetic field is generated.

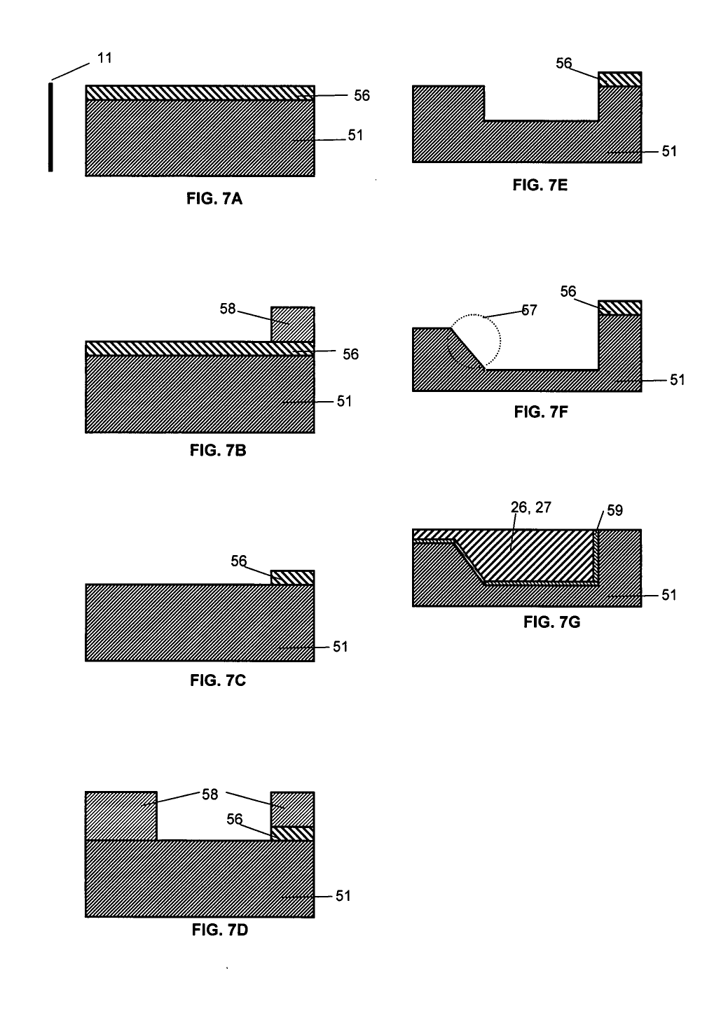

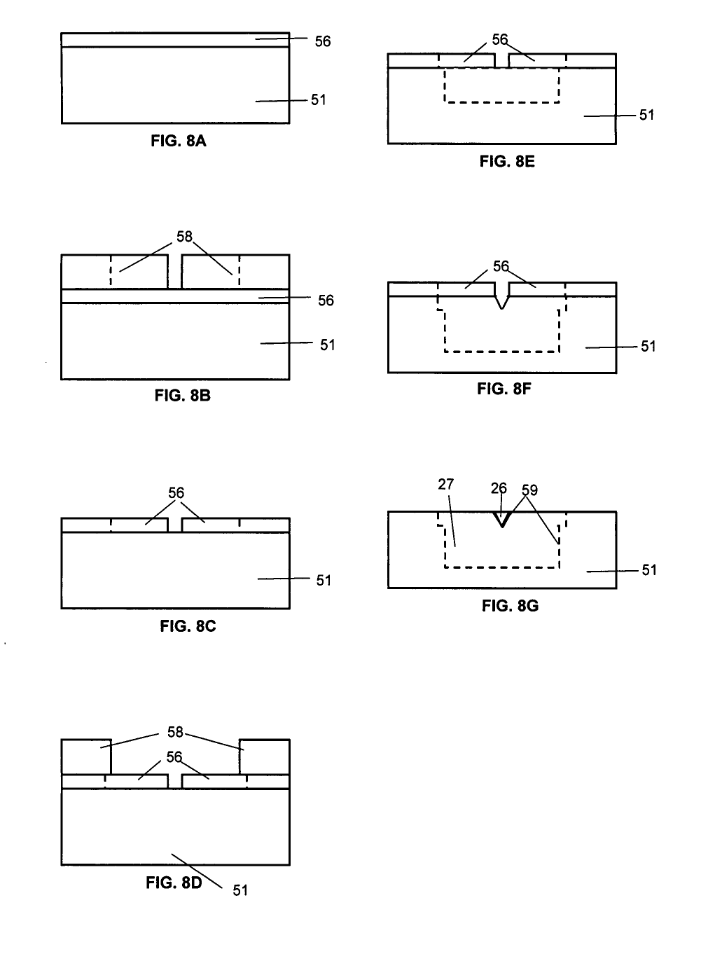

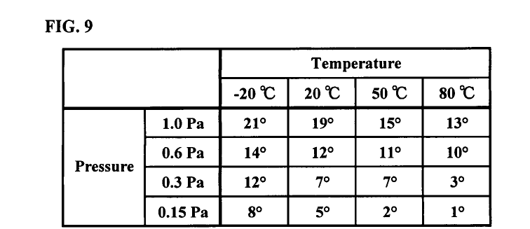

Continuing, the manufacturing method according to the first embodiment will be described. FIGS. 7A to 7G and FIGS. 8A to 8G show the main magnetic pole formation process of the first embodiment. FIGS. 7A to 7G show cross sections after completing each process while forming a main magnetic pole. In the following, cross sections show a cross section of the center area of an edge surface. The side where the recording medium 11 is positioned on a cross sectional view is the direction of the air bearing surface. FIGS. 8A to 8G show edge surfaces on the air bearing surface side corresponding to FIGS. 7A to 7G, respectively. In the following, details of FIGS. 7A to 7G and FIGS. 8A to 8G will be described.

As seen in FIG. 7A and FIG. 8A, a sputtering method is used to form the hard mark layer 56, composed of for example an Ni—Fe based alloy, Fe—Co based alloy, or a Ta/Ni—Fe based alloy, at a thickness of approximately 40 nm to 300 nm on the alumina layer 51 composed of Al₂O₃.

A spin coat method is used to form a Novolac resin that contains a light sensitive agent as a resist layer 58 (FIG. 7B, FIG. 8B), and the resist layer 58 is patterned so as to correspond to the outline of the main magnetic pole layer 27 using a KrF stepper.

With the patterned resist layer 58 functioning as a mask, RIE is used to dry etch the hard mask layer 56 patterning the hard mask layer 56 so as to correspond to the outline of the main magnetic pole layer 27 (FIG. 7C, FIG. 8C). Continuing, the resist layer 58 is removed by means of O₂ ashing.

A spin coat method is used again to form a Novolac resin that contains a light sensitive agent, as a resist layer 58 at a thickness of approximately 1.6 μm (FIG. 7D, FIG. 8D). The resist layer 58 is patterned so as to correspond to the outline of the main magnetic pole brace layer 27 using a KrF stepper. Here, the outline of the main magnetic pole brace layer 26 is formed within the outline of the main magnetic pole brace layer 27.

With the patterned resist layer 58 functioning as a mask, RIE is used to perform a dry etch and etch the alumina layer 51 to a depth of approximately 0.3 μm to 0.4 μm (FIG. 7E, FIG. 8E). Consequently, the shape of the second groove corresponding to the outline of the main magnetic pole brace layer 27 is formed in the center of the alumina layer 51. Continuing, the resist layer 58 is removed by means of O₂ ashing. At this time, the patterned hard mask layer 56 that corresponds to the outline of the main magnetic pole layer 27 exists on the alumina layer 51.

With the patterned hard mask layer 56 as a mask, RIE is used to perform a dry etch, and etch the alumina layer 51 to a depth of approximately 0.3 μm (FIG. 7F, FIG. 8F). Here, the shape of the first groove corresponding to the outline of the main magnetic pole layer 26 is formed in the center of the alumina layer 51. At this point, the shape of the second groove corresponding to the outline of the main magnetic pole brace layer 27 is etched simultaneously and the depth of the first groove is finalized at approximately 0.3 μm to 0.4 μm. According to this process, the groove formed together with the main magnetic pole brace layer 27 and the main magnetic pole layer 26 is formed without using a CMP process. Here, RIE has a characteristic which makes the outline of the main magnetic pole brace layer 27 smaller than the outline of the main magnetic pole layer 26, thereby giving priority to etching the unmasked corner. By means of this characteristic, the corner 57 on the air bearing surface side of the groove of the alumina layer 51 that corresponds to the outline of the main magnetic pole brace layer 27 can be angled. It has been reported that forming of this type of shape increases the flux density of the main magnetic pole. (As an example refer to J. Appl. Phys. 93, 7738, 2003 as a non-patent reference.) In addition, as a result of earnest research the inventors discovered that the taper angle 43 of the edge surface of the end of the main magnetic pole can be controlled at an arbitrary angle by means of controlling the pressure and temperature conditions during RIE etching. FIG. 9 shows the relationship of pressure and temperature with respect to the taper angle for the type of main magnetic pole formation process of the present invention. As seen in FIG. 9, the angle can be controlled by means of controlling the pressure (between 0.15 Pa and 1.0 Pa) and temperature conditions (between −20° C. and 80° C.).

Referring now to FIG. 7G and FIG. 8G, a nonmagnetic metal selected from among, for example, Ti, Ru, Ta, or Cr, is formed at a thickness of 5 nm to 10 nm as the plating base layer 59. Next, an electrolystic plating method is used to form the main magnetic pole brace layer 26 and the main magnetic pole layer 27 at the same time using a strong magnetic material selected from among, for example, Ni—Fe or Fe—Co based alloys. To complete the process the upper portion of the main magnetic pole layer 27 is polished using CMP.

According to the composition of the first embodiment, the main magnetic pole layer and the main magnetic pole brace layer can be formed at the same time. Because of this, a polishing process using CMP during the process that forms the main magnetic pole layer and the main magnetic pole brace layer is not required. Since the problem of film thickness variation due to CMP does not occur, it becomes possible to form the main magnetic pole with very favorable accuracy. Consequently, an angle on the main magnetic pole brace layer is eliminated and there is no interpositioning of a nonmagnetic layer between the main magnetic pole layer and the main magnetic pole brace layer. Therefore, the main magnetic pole layer and the main magnetic pole brace layer are integrally formed and the film thickness of the entire main magnetic pole is narrowed down. And because of this, the write magnetic field strength can be increased.

While the principles of the invention have been described above in connection with specific apparatus and applications, it is to be understood that this description is made only by way of example and not as a limitation on the scope of the invention.

What is claimed is:

1. A magnetic head manufacturing method comprising steps of:
forming a first groove in a shape corresponding to an outline of a main magnetic pole on an insulation layer, and
forming a second groove corresponding to an outline of a main magnetic pole brace layer, inside the outline of the main magnetic pole,
using a plating method to fill the first and second grooves at the same time with a ferromagnetic material and form a main magnetic pole and a main magnetic pole brace layer at the same time.

2. The magnetic head manufacturing method according to claim 1, wherein a gas pressure of reactive ion etching that forms the first and second grooves is between 0.15 Pa and 1.0 Pa.

3. The magnetic head manufacturing method according to claim 1, wherein a processing temperature for reactive ion etching that forms the first and second grooves is between −20° C. and 80° C.

4. The magnetic head manufacturing method according to claim 1, wherein the main magnetic pole brace layer is provided at an angle in relation to a direction of an air bearing surface of the main magnetic pole.

5. A magnetic head comprising:
a main magnetic pole layer arranged perpendicular to an air bearing surface, and
a main magnetic pole brace layer that is arranged adjacent to and in a thickness direction of the main magnetic pole layer further from the air bearing surface than the main magnetic pole,
wherein the main magnetic pole layer and main magnetic pole brace layer are continuously formed by a ferromagnetic material.

6. A magnetic storage device comprising:
a magnetic head wherein a magnetic layer and a main magnetic pole brace layer are continuously formed of a ferromagnetic material, and
a magnetic disk that is a recording medium.
